(19) United States
(12) Patent Application Publication
(10) Pub. No.: US 2012/0143619 A1
(43) Pub. Date: Jun. 7, 2012

(54) Telecommunications System for Monitoring and for Enabling a Communication Chain Between Care Givers and Benefactors and for Providing Alert Notification to Designated Recipients

(76) Inventor: Karen E. Routt, Redwood City, CA (US)

(21) Appl. No.: 13/301,361

(22) Filed: Nov. 21, 2011

Related U.S. Application Data
(63) Continuation of application No. 12/172,475, filed on Jul. 14, 2008, now abandoned.
(60) Provisional application No. 60/961,033, filed on Jul. 18, 2007.

(51) Int. Cl. G06Q 50/22

(52) U.S. Cl. 705/2

(57) ABSTRACT

A service for facilitating monitoring of individuals on behalf of one or more caregivers has an Internet-connected server, software executing from a digital storage medium associated with the server, an interactive interface provided by the software for enabling individuals to input information and to access the service, and information stored in a data repository associated with the server regarding at least contact data for the individuals, media files representing recorded voice messages, and schedule parameters for initiating and processing call requests directed from the one or more caregivers. The one or more caregivers may subscribe to the service and may provide specific contact data and configuration data for system use and wherein the system may according to schedule initiate proxy contact attempts on behalf of the one or more caregivers based on the contact and configuration data, including reporting contact attempt results and recording and forwarding any contact replies.

### CROSS-REFERENCE TO RELATED APPLICATIONS

The present invention is a continuation application of co-pending U.S. application Ser. No. 12/172,475, filed Jul. 14, 2008, which claims priority to a U.S. provisional patent application Ser. No. 60/961,033, filed Jul. 18, 2007 and entitled “Computer Telephony Messaging System”. Disclosures of which are incorporated in their entirety by reference.

### BACKGROUND OF THE INVENTION

1. Field of the Invention

The present invention is in the field of telecommunications including computer telephony integrated (CTI) systems and methods and pertains particularly to a system and service enabling monitoring, alert notification and communication between care givers and care recipients.

2. Discussion of the State of the Art

Care of the elderly is a nationally growing phenomenon as more and more persons are living well past life expectancy averages that were typical of the last decade at the time of this writing. Increased life expectancy of elderly persons is due mainly to more recent technological advances in the medial professions and in the pharmaceutical industries.

Elderly persons in general are more and more independent for much longer periods of time than has been the case in recent past. This has resulted in an explosion of numbers of persons who, at the time of this writing, are giving care to one or more elderly persons, generally those persons that are family members or even close family friends.

Recent laws have been written and passed in many states that attempt to provide some relief for those individuals obliged to engage in caring for one or more elderly persons, typically relatives. Most of these laws involve employment benefits that allow employees some paid time for caring for the elderly or interred and certain tax relief measures designed to compensate persons engaging in volunteer care giving.

Caring for a semi-independent elderly relative can be a very demanding and time consuming task, which may be ongoing for increasingly extended periods of time. Workers who have elderly parents or grandparents, for example, may lose time and productivity on the job and may suffer pay decreases and missed advancement opportunities in the organizations they work for. Large, medium and small businesses employing moderate to large numbers of care-givers may lose business productivity and suffer reduced profits in the face of existing regulation giving employees in general certain rights such as paid family leave to care take elderly family members without being replaced or terminated. Stress and tension accompany caring for the elderly or other semi-independent adult relatives that may have some minor physical or mental disability that requires some form of monitoring by a third party. Family relations with immediate family can be affected by the stress and tension as well as on-the job relations with co-workers, etc.

Therefore, what is needed is a system that enables communications to be directed to the elderly and communications replies and system result notifications resulting from such communications or failure thereof to be directed back to care givers by proxy in a fashion that reduces the actual time devoted to and work directed to the personal care of an elderly care recipient or disabled adult.

### SUMMARY OF THE INVENTION

The problem stated above is that it is desirable that a care benefactor living an independent or semi-independent lifestyle receive care and attention from a care giver that is typically a relative, but many of the conventional means for monitoring such benefactors for the purpose of delivering care, such as, by personal contact and direct communication also create stress for the care giver and tension in the care giver's environment. The inventor therefore considered functional elements of a computer telephony integrated (CTI) contact system, looking for elements that might exhibit personalization and automation and that could potentially be harnessed to provide ongoing and supportive contact between a care giver and care benefactor but in a manner that would not create stress and tension.

Many care benefactors requiring periodic care and monitoring are mildly disabled, elderly, or mentally impaired to some degree but still insist on living largely independent lives free of around the clock supervision such as might be provided by a nursing facility or a more structured clinical environment. A by product of such an arrangement is a requirement or duty by relatives or other appointed care givers to monitor and provide care to the benefactor when needed, which may be quite often. Most care givers charged with caring for an elderly or otherwise compromised relative deal directly with their charges via direct communication and perform frequent visits, drive-bys, tasks and so on taking time away from their own families and work obligations. Although laws exist that support such care for family members, they are imperfect, limited in scope, and not sufficient to mitigate the stress and tension that may accompany the absence of the employee due to caring for such a relative.

The present inventor realized in an inventive moment that if, during a period of time, direct contact could be made with a care benefactor and a communication chain or thread could be established between the care giver and care benefactor by proxy, significant tension and stress reduction might result. The inventor therefore constructed a unique communication and monitoring service for care benefactors and their care givers that allowed care givers to monitor and effectively communicate with their charges without a significant deviation from family or work obligations. A significant improvement in stress and tension levels results with no added risk to the care benefactor.

Accordingly, in one embodiment of the invention a service for facilitating monitoring of individuals on behalf of one or more caregivers is provided. The service includes an Internet-connected server, software executing from a digital storage medium associated with the server, an interactive interface provided by the software for enabling individuals to input information and to access the service, and information stored in a data repository associated with the server regarding at least contact data for the individuals, media files representing recorded voice messages, and schedule parameters for initiating and processing call requests directed from the one or more caregivers.

The service allows the one or more caregivers to subscribe to the service and accepts specific contact data and configuration data for system use and wherein the system may according to schedule may initiate contact attempts by proxy on behalf of the one or more caregivers based on the contact and configuration data, including reporting contact attempt results and recording and forwarding any contact replies.

In one embodiment of the service, monitoring is by telephone or by voice messaging. In a preferred embodiment the interactive interface is a browser-based interface. In most embodiments individuals monitored comprise one of elderly persons or mentally impaired individuals that maintain independent to semi-independent lifestyles.

In one embodiment of the service there is more than one care giver, the care givers belonging to a group subscribed to the service as an enterprise. In one embodiment the service calls the care giver or care givers to solicit messages before attempting to contact one or more care benefactors during a given service window. In one embodiment telephone equipment adapted to practice the invention is leased for the purpose of facilitating the service. In one embodiment the contact parameters are telephone numbers and the media files are voice files useable by an interactive voice response system.

According to another embodiment of the present invention, a method for initializing monitoring of care benefactors by proxy is provided. The method includes the steps (a) providing to a service through an interactive interface, parameters for monitoring one or more care benefactors including defining a service window, (b) providing to the service through the interactive interface, parameters for sending notification relative to contact attempt result states during monitoring, (c) providing to the service through the interactive interface or through a voice connection, one or more messages for voice presentation to care benefactors, and (d) activating a service window of time within which monitoring commences.

In one aspect of the method the care benefactors are elderly or physically or mentally impaired individuals leading an independent or semi-independent lifestyle. In a preferred aspect in step (a) the parameters include care benefactor identification, contact information, optionally commitment schedule information of the care benefactor. In this same aspect in step (b) the parameters include notification recipient identification, contact information, and optionally emergency plan instructions. In steps (a) through (c) the interactive interface is a Web-based interface accessible through an Internet-connected server.

In one aspect of the method at step (c) the one or more messages are typed into a dialog box of the interactive interface and then are parsed and converted into synthesized voice messages. In another aspect the one or more messages are spoken over the voice connection and recorded as digital voice files. In a preferred aspect the voice messages are presented to care benefactors over a voice connection using a voice application running on an interactive voice response unit. In this aspect the voice connection is a connected telephone call.

In one aspect of the method in step (d) activation of the service window is automatic and performed by the service. In another aspect of the method step (c) occurs periodically just before call attempts are made within a given service window. In one aspect of the method in step (c) the voice connection is one of a telephone or voice over Internet protocol (VoIP) connection.

For the first time a telecommunications service is provided that enables monitoring of care benefactors and enables communication between the same by proxy allowing care givers to better balance their time between work, immediate family, and their adult benefactors.

### BRIEF DESCRIPTION OF THE DRAWING FIGURES

FIG. 1 is an architectural view of a communications network over which the invention may be practiced according to at least one embodiment.

FIG. 2 is a contact sequence chart illustrating a process for registering for and using the service of the present invention according to an embodiment of the present invention.

FIG. 3 is a block diagram illustrating basic components implemented as software (SW) running on hardware of the system of the invention.

FIG. 4 is a contact sequence chart illustrating a process for contacting a care benefactor and providing call attempt notification results.

FIG. 5 is a process flow chart illustrating a process for receiving a call prompt and recording a reply.

FIG. 6 is a process flow chart illustrating a process for configuring and initiating service according to an embodiment of the present invention.

### DETAILED DESCRIPTION

The inventor provides a unique telecommunications system and service for allowing care givers un-fettered access to care benefactors in their charge in a way that reduces overall confusion, stress and work related to caring for elderly and other less than fully independent persons. The invention uses a proxy communications system to provide asynchronous messaging and alert notification to care givers and authorized third-party entities. The invention is described in detail according to the various embodiments presented hereafter in this specification.

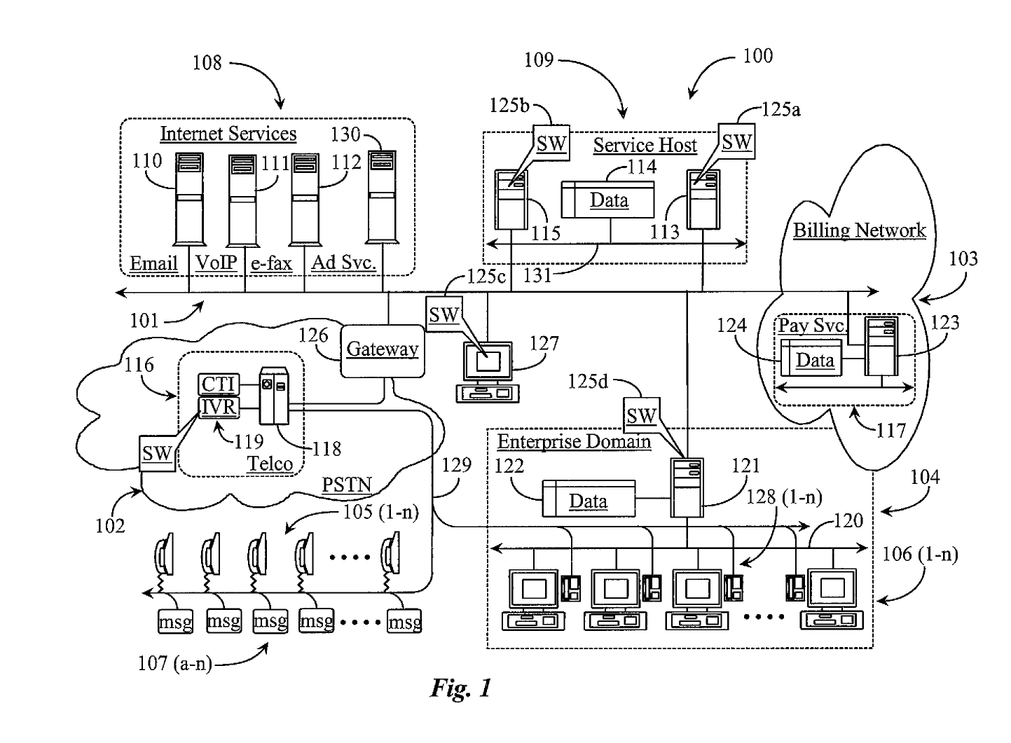

FIG. 1 is an architectural view of a communications network 100 over which the invention may be practiced according to at least one embodiment. Communication network 100 incorporates the Internet network represented herein by a network backbone 101. Network backbone 101 represents all of the lines, equipment, and access points that make up the Internet network as a whole. Therefore, there are no geographic limits to the practice of the present invention.

A service host 109 is illustrated in this example and may represent any company that may provide subscription-based services to a client base comprising caregivers who are responsible for one or more individuals that require some form of monitoring or care provision. In a typical situation a care giver is a person that is caring for an elderly parent for example. In another example, a caregiver may be a professional caring for one or more independent care benefactors like one or more elderly or somewhat disabled persons that are still living an independent lifestyle.

Service host 109 includes a local area network (LAN) represented herein by a LAN backbone 131. LAN 131 is adapted for Internet protocols and may be considered a sub-network of the Internet. In this example, a server 113 is provided having accessible thereto a digital storage medium having thereon an executable software (SW) 125a provided for the purpose of enabling users to register with service host 109 to access services and to configure the service to monitor or check in with one or more care benefactors on behalf of the user.

Server 113 is connected to LAN backbone 131 and may also be connected directly to Internet backbone 101. Server 113 may be configured as a contact, registration, and configuration server as well as a point of service access over the Internet. Therefore, SW 125a includes one or more Web-based interactive interfaces that users may input data into and submit to the service in the course of practice of the invention. Such interfaces may be browser-nested interfaces that are called by users interacting from a Web page provided by service host 109.

Information provided to the service through one or more interactive interfaces of SW 125a may include care giver information for contact, notification, and billing purposes. Care benefactor identification and contact parameters are provided to the service to enable care benefactor contact on behalf of care givers. In this regard, scheduling information may also be provided to the service relative to an ongoing window of time whereby the service operates on behalf of the subscribing care givers to periodically check in on care benefactors.

A data repository 114 is provided on LAN 131 and associated with server 113 by LAN connection. Repository 114 may be an optical or magnetic based storage medium or some other persistent memory-based data storage facility. Repository 114 is adapted to store all of the important data required by the service to enable practice of the invention including user care giver data, care benefactor data, contact information, billing information, notification parameters, and rules associated with contacting care benefactors.

A server 115 is provided within the domain of service host 109 having accessible thereto a digital storage medium having thereon an executable software (SW) 125b provided for the purpose of accepting call requests from care givers and for initiating scheduled or periodic contact attempts to care benefactors based on information provided by care givers and according to rules configured for such contact attempts. Server 115 is provided within the domain of service host 109 and is connected to LAN 131 and directly to Internet backbone 101. In one embodiment, a care giver may pre-configure a service to make repeated contact attempts over a period of time to reach a care benefactor by telephone, for example, in a way that is personalized by the care giver through provision of recorded voice messages played as prompts by the system when connected to a care benefactor. SW 125a may include voice recording components as well as text to speech components adapted to convert typed text to synthesized speech.

Server 115 may be adapted as a contact initiation server charged with, among other possible tasks, processing a request for contact, simply termed a call request, for execution by the appropriate interface connected to the appropriate carrier network supporting the connection. SW 125b may include application program interfaces to various network-based communications services that can be leveraged to facilitate contact attempts. For the most part, contact attempts are telephone calls made by the service to care benefactors. However, this should not be construed as a limitation of the present invention as other types of contact may also occur depending on the communication capabilities of the care benefactors.

Communications network includes a billing network 103 adapted to handle transactions generated by the service of the present invention. A payment service provider 117 is illustrated in this example and may represent any company adapted to process transaction for care givers subscribing to services hosted by service host 109. Provider 117 has a server 123 having accessible thereto a digital storage medium having thereon an executable software (not illustrated) provided for the purpose of accepting and processing transaction requests relative to billing subscribers for services and receiving payment for services rendered.

Provider 117 may be an online payment processing service, an online bank, or other financial institution such as credit card processing service. Server 123 is associated with a data repository 124. Data repository 124 is adapted to store billing data such as user account information that is required to render payments to service host 109 on behalf of care givers who subscribe to services. In one embodiment, the service host may handle all of the billing of clients.

The service of the present invention may be practiced by a group of care givers organized as a subscribing group. The service may also be practiced by single individual subscribers caring for an elderly or other care benefactor. Communications network 100 includes a public switched telephone network (PSTN) 102 bridged for communication to Internet 101 by a gateway 126. Gateway 126 may be an SS-7 or other telephony gateway capable of transferring voice calls between dedicated and shared lines from the telephone network over the Internet and from the Internet over the telephone network.

PSTN 102 may be a private telephone network instead of a public network without departing from the spirit and scope of the present invention. Likewise, a cellular telephone network may also be represented in this example in addition to PSTN 102. A telephone company (Telco) service provider 116 is illustrated within PSTN 102 and is adapted to provide certain telephone services including leasing of telephone equipment. In one embodiment, service host 109 may lease certain services and/or equipment from Telco 116 to facilitate practice of the present invention without being required to purchase and maintain telephone switching facilities, interactive voice response units (IVR) and the like.

A telephone switch 118 is illustrated within the domain of Telco 116 on PSTN 102. Switch 118 may be a private branch exchange (PBX), an automated call distributor (ACD) or other switch capable of processing telephone calls. Switch 118 is computer telephony integrated (CTI) by virtue of a CTI intelligent peripheral 119 that includes IVR capability. Peripheral 119 has a digital storage medium accessible thereto having thereon executable software (SW) adapted to provide IVR and switching intelligence to telephone switch 118. SW running on peripheral 119 may be adapted in part to direct IVR function according to various needs of the service of the invention including identifying care benefactors, playing prompts, and recording responses from care benefactors during IVR interactive sessions resulting from successful call attempts placed by the service.

Switch 118 is connected by a telephone line 129 to care benefactor telephones 105 (1-n) representing individual care benefactors. Telephones 105 (1-n) represent individual care benefactors located anywhere that may be accessible by land-line telephone including at home or in some care facility. In addition to a telephone, an electronic message box (107 1-n) capable of receiving and sending email is illustrated with each telephone 105 (1-n), the message boxes also connected to line 129. Message boxes 107 (1-n) are illustrated in this example only to illustrate that the invention is not limited to contacting care benefactors by telephone handset but can include other forms of contact like email, or cellular telephone. Many elderly persons do not operate computers but do participate in email correspondence via dedicated and easy to operate email appliances. Not excluding other forms of communication, telephone is likely the most prominent contact medium used by the service simply because of the nature of the recipients to rely mostly on the telephone for connecting to the outside world.

An enterprise domain 104 is illustrated in this example and has connection to Internet backbone 101 through a server 121 connected to a LAN 120. Enterprise 104 may be any organization or company having employees that are care givers. Employee stations 106 (1-n) are illustrated in this example as LAN-connected computers. Telephones (128 1-n) are provided one telephone per station, the telephones connected to switch 118 by telephone line 129. In the case of enterprise domain 104, each employee that is also a care giver to one or more care benefactors is included in a company wide or corporate subscription to the service provided by service host 100.

Server 121 is provided within domain 104 having accessible thereto a digital storage medium having thereon an executable software (SW) 125d provided for the purpose of enabling care givers 106 (1-n) to access services and configure personal schedules and parameters for service monitoring of care benefactors. In one embodiment SW 125d is a client application of SW 125a and includes all of the required interactive interfaces for enabling access to and configuration of services. In another embodiment SW 125d is a turnkey SW application executable from server 121 and independent from host service 109. In this case SW 125d may contain all of the functionality of SW 125a and SW 125b. Server 121 may operate both as a registration and configuration server and as a contact initiation and reporting server. Likewise, the functions of SW 125a and SW 125b and servers 115 and 113 at service host 109 may be combined to run on a single machine or distributed over several machines without departing from the spirit and scope of the present invention.

A data repository 122 is provided and made accessible to server 121. Repository 122 may hold all of the data required top enable the service of the invention including data types described above with reference to repository 114. In one embodiment SW 125d is a client application and repository 122 contains replicated data also stored in repository 114 held at service host 109. In either case of possible service hosting (host 109 or domain 104), care givers may schedule a window of time for service operation to attempt contact of care benefactors on behalf of care givers. Care givers 106 (1-n) may be associated through the service of the invention with care benefactors 107 (1-n). Care benefactors do not require any software or special hardware to participate in the service.

A solitary care giver 127 is illustrated in this example by a personal computer (PC) icon connected by Internet access line to Internet 101. PC 127 has a digital storage medium accessible thereto having on it an executable SW 125c adapted to enable the operator of computer 127 to access services and to configure the service to monitor one or more care benefactors by proxy. SW 125c is a client application to SW 125a and SW 125b and may be downloaded from server 113 and executed from a browser-nested control such as an executable icon on a browser tool bar, for example. The illustration of a solitary care giver via PC 127 is intended to demonstrate only that service host 109 may entertain both single user subscriptions and group subscriptions.

Server 115 has direct Internet connection, preferably 24/7 high speed connection, and may contact and utilize other servers and applications for communications purposes. As a contact initiation server, server 115 may not actually dial a number or attempt any direct communication with a care benefactor. Rather, the server may prepare and send a contact or a notification request (if appropriate) that is queued for execution at an appropriate interface such as at switch 118 for a telephone call, or to one of a variety of communications service points. Internet services 108 are illustrated in this example and include an email server 110, a voice over Internet protocol server (VoIP) 111, and an electronic fax (e-fax) server 112.

Telephone is the most probable medium for contacting and delivering a voice message to a care benefactor. However, VoIP and email may also be used to initiate contact and to deliver a voice message including provision of an opportunity for voice message reply. Replies from care benefactors may be delivered back to care givers according to any desired medium such as by telephone, IP phone, email, short message service (SMS), instant message, fax, etc. The care giver may configure defaults for replies and for notification alerts.

In use of the present invention a care giver such as one of care givers 106 (1-n) registers with the service and provides the required information to activate the service. Billing information, care benefactor information, and service configuration parameters are required by the service. Once registered with the service, the care giver and care benefactor is known to the service. In one embodiment relative to notification recipients who are not the care giver or care benefactor may be added to the mix. A notification recipient is any person or entity that will receive some kind of alert or notification according to some resulting state of an attempted contact between the service and a care benefactor.

All subscribers to the service may be allotted provided with one or more personalized service pages containing general information and links to service configuration interfaces and service activation executables. The service may provide a unique identifier to both care givers and to registered care benefactors for cross association purposes and for care benefactor validation during contact attempts. Therefore all of the data provided by the care giver to the service may be associated under or tagged with the appropriate identifier. When a care giver logs into the system and authenticates, the care giver's care benefactor information is readily accessible to the system.

A care giver such as one of care givers 106 (1-n) may configure a window or multiple windows within which the service will attempt to contact a care benefactor on behalf of the care giver and deliver a voice message for the care giver. Voice messages may be pre-recorded messages or they may be recorded just before a scheduled contact attempt. Contact attempts consist of the service dialing one or more contact numbers for a care benefactor. If an attempt at contact results in a call pickup of a ringing event then the service using an IVR such as IVR (119) will attempt to validate the identity of the party that answered the phone as the care benefactor by asking them to push a specific touch tone button or sequence of buttons, or by prompting the care benefactor to say a code or password.

When the service has the correct care benefactor online, the IVR may play a voice message from the care giver to the benefactor. The voice message may be personalized by using the actual voice of the care giver or it may be synthesized voice assembled from typed text. The service plays the voice message as a prompt and provides an opportunity for the care benefactor to craft a reply by recording a response that will be delivered back to the care giver. Regular correspondence between the care giver and care benefactor may occur in this fashion through the service making periodic contact attempt and reporting back to the care giver.

The care giver may set up a call window with the service such as a period of time during a day, today, two or more days, or a longer period like a week or more where within the service will actively place calls to the care benefactor on behalf of the care giver. The calls may be randomly dispersed over the window by the service or they may be specifically scheduled by the care giver. The care giver may also provide care benefactor schedule information to the service so in the event that the service chooses when exactly to call, the service may know when the care benefactor is likely to be unavailable to accept a call.

The care giver may at any time upload new information to the service relative to new contact data, new notification parameters, and service configuration changes. A company subscribing to the service may create certain rules of engagement for care-giver employees. In one scenario the service may call a care giver at his or her work extension periodically during a work period to inquire if a contact attempt should be made to the registered care benefactor. IVR technology is used to validate the care giver and ask if a call attempt should be made. The care giver can respond yes or no and may choose from a number of pre-recorded messages of a general nature, or may create a voice message on the fly for the service to use in a next contact attempt. Replies from care benefactors created on the fly may be delivered back to care givers according to a desired media.

In one embodiment advertisements may be incorporated as part of the interaction between the service and a care benefactor and between the service and the care giver. In this example one of Internet services 108 is an advertisement server 130. Server 130 is adapted to server advertisement media to the service of the invention for insertion into the interactive process. Ads may be personalized according to parameters known to the system about the care giver and care benefactor. In one embodiment advertising may be played in conjunction with background music during certain portions of IVR interaction. In one embodiment advertising may be embedded into emails and notification messages as well as in voice replies. Advertisements may be dynamic or static.

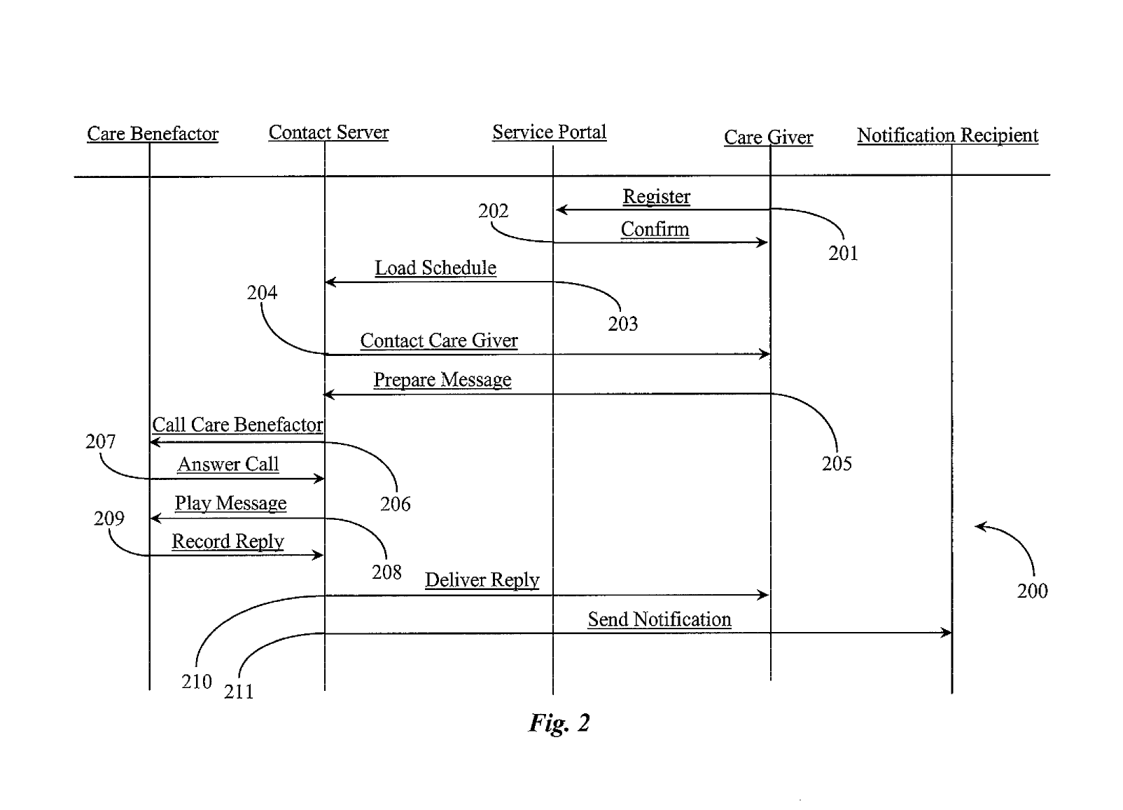

FIG. 2 is a contact sequence chart illustrating a process 200 for registering for and using the service of the present invention according to an embodiment of the present invention. Process 200 begins with a care giver registering with the service at step 201 and receiving a confirmation of registration and service activation at step 202. The care giver may perform such registration through an interactive service portal and Web page from a computer browser interface running on a PC, a cellular telephone, or another Internet capable appliance. During registration, the care giver registers all care benefactors subject to the service. The service may charge more for additional benefactors configured with the service. At confirmation, the service may send unique ID parameters for benefactors and the care giver and instructions for using them to the care giver in email as well as in interactive display for screen printout.

If a call schedule has been configured, it may be loaded by the service into a contact server at step 203. The difference between a contact initiation server and a contact server is that a contact server actually places outgoing calls using an automated dialer. In one embodiment, a schedule includes call attempt windows and requires that the service first call the care giver to receive confirmation of a pending contact event. In this case the service contacts the care giver at step 204 according to care giver instructions and preferred media type. That contact may be a telephone IVR call, a VoIP call, or some text message. The care giver is given the opportunity to prepare a message to be delivered to the care benefactor at step 205. The message may be recorded as a voice message or it may be typed into an input dialog box and then converted to a synthesized voice using a text to speech application. The care giver may choose an existing message that has been pre-recorded or a system default message can be selected.

In one embodiment a voice sample may be taken of the care giver so that a typed message may be converted to a voice file using a synthesized voice patterned after the voice sample of the care giver in terms of tone and inflection. The prepared message is delivered to the contact server at step 205 and incorporated into a voice application used by the IVR unit. The contact server attempts to contact the benefactor at step 206. This attempt may be a telephone call to the primary contact number of the benefactor. The benefactor may answer the call at step 207. If the call is answered the system plays a message at step 208. The system may first identify itself by a trade name or brand name familiar to the benefactor and then may ask for validation of the benefactor by prompting the benefactor to input or vocalize some ID number confirming that the party is indeed the benefactor.

The system may prompt the answering party if not the benefactor if the benefactor is available. Some time may be permitted for the benefactor to come to the telephone. The process may loop back to the validation step so that the benefactor may then validate to the system. After validating to the system, the voice application may play the voice message from the care giver to the benefactor. After playing the message the system may prompt the benefactor for a voice reply which, if given, is recorded by the IVR system. The benefactor may be given an option to pre-record one or more voice messages that can be identified and used as a reply to a general message prompt sent from a care giver.

After a voice reply is recorded, the system may prompt the user for satisfaction level relative to the message at step 209. If the benefactor is satisfied with the reply after the reply is played back to the benefactor then the call may be terminated with the reply saved for delivery. If the benefactor is not satisfied with the current recorded message at playback the process can be restarted to record another message discarding the previous one.

At step 210 the contact server contacts the care giver to deliver the voice message reply from the care benefactor. This may be accomplished according to preference of the care giver relative to contact information and media type. It may be a telephone call to a primary number followed by an IVR interaction to identify the service and validate the recipient as the actual care giver. Once the care giver validates to the system the voice reply from the care benefactor can be played to the care giver. Other options may be preferred like getting the reply in email as a voice mail or in a VoIP call. The message can be converted into text using a voice to text application and then sent in a text message to the care giver. SW at the site of the care giver may cause an audible alert or pop-up alert to sound or display on the recipient device so that the care giver is immediately alerted of the benefactor reply. A system notification detailing results of the exchange can be sent to one or more notification recipients at step 211.

A notification recipient may include the care giver and/or any third party person and/or any automated system capable of receiving the notification. A care giver may pre-configure how notifications and alerts are handled and who will receive them. In one embodiment no notification is sent if the call was successfully answered and a reply was sent back to the care giver on behalf of the benefactor. A notification or alert may be delivered, for example, if no answer resulted in a failed contact attempt. In the case of email contact between the system and the benefactor on behalf of the care giver, a read receipt sent back to the email server may serve as evidence of a successful contact. If no read receipt is received after a period of time, an alert may be generated and the contact attempt may be marked as a failed attempt.

A benefactor may open an email containing a voice message (voice mail) from the care giver. After listening to the care giver's message, the email application may prompt the benefactor to record a reply. Recording SW may be used by the interface to digitally record the message and embed it into a message reply ultimately delivered back to the care giver. Video messaging may also be used to practice the invention. The contact server may make a pre-configured number of attempts to contact a care benefactor before reporting a failed attempt. More than one telephone number or contact parameter may be employed. The system may first use a highest priority number followed by a lower priority number selected automatically when the first number called results in a failed attempt to contact.

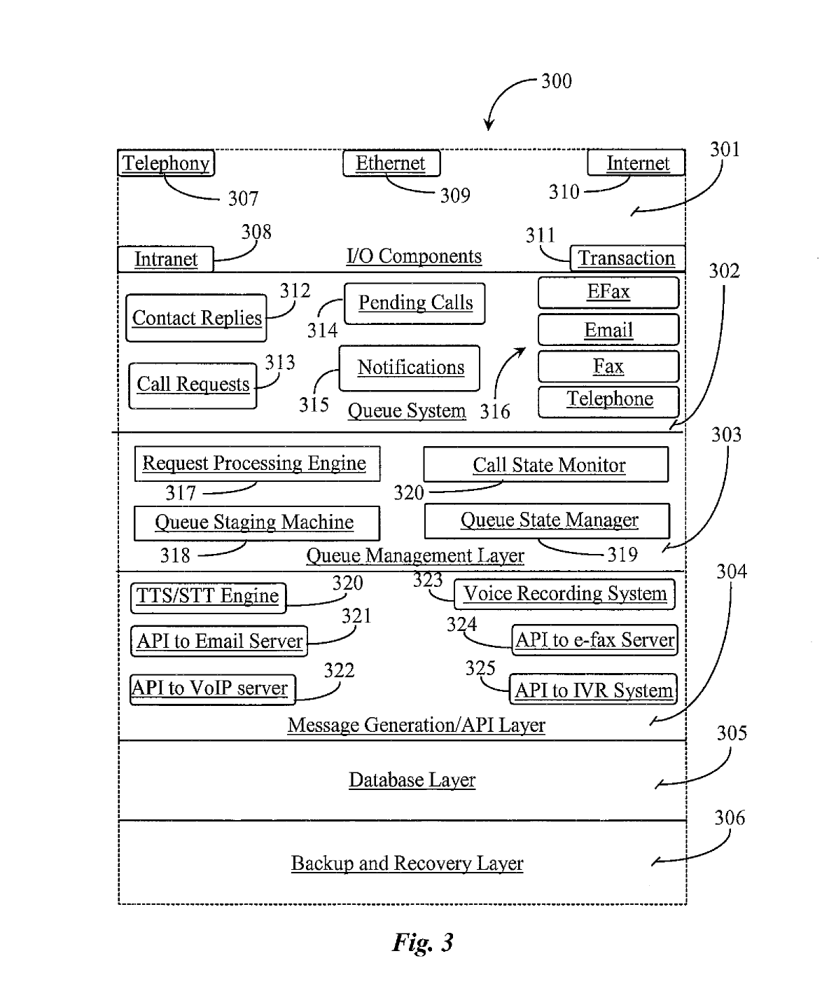

FIG. 3 is a block diagram illustrating basic components 300 implemented as software (SW) running on hardware of the system of the invention. Components 300 may be provided together as a SW application executable from a digital medium associated with a single machine. Components 300 may also be distributed components executing from more than one machine.

Taken together as one application, components 300 may be installed on a digital storage medium as software and/or firmware executable by and accessible to one or more servers such as a contact initiation server similar to server 115 of FIG. 1. An input/output (I/O) component layer 301 is provided and may include hardware and software port components depending on the hardware used. In this example an I/O telephony component 307 is provided to enable access and use of telephony services. An I/O component to an Intranet 308 enables access to other nodes and services on an Intranet network. A similar I/O Ethernet component 309 enables access to other nodes and services located on a connected LAN. An I/O Internet component 310 enables access to other nodes and services located any where on the Internet network. An I/O transaction component 311 enables access to other nodes and services on a financial transaction or billing network.

I/O components in layer 301 may be hardwired and dedicated server network ports or soft channels connected to a single I/O port on a machine depending on application. The service of the invention responds to requests from care givers and incorporates various communication message or request queues. A queue implementation layer 302 is supported by a digital memory sufficiently large to accommodate incoming and outgoing queues and queue processing SW. Layer 302 includes an incoming queue 313 adapted to accept call requests from care givers. An outgoing queue 314 is provided to queue up pending calls. The host machine may or may not include an onboard telephony dialer. Outgoing queue items may be processed as activated requests that contain the contact instructions and parameters and instructions for IVR or other interactive communication.

For telephone calls, queue 314 holds telephone call requests, which may be sent to a telephone service for implementation. A contact server, a telephone switch, and an IVR system may be incorporated to complete the call attempts and provide interactive sessions with the care benefactors. An incoming queue 312 is provided for queuing up replies from care benefactors solicited at successful contact attempts. Contact replies in queue 312 may be processed according to care giver media preferences and may be queued for outgoing in any of outgoing media queues 316, which include an e-fax queue, and email or messaging outbox, a fax outgoing queue, or an outgoing telephone request queue. A notification outgoing queue is also provided within layer 302 and is adapted to queue notification sent to third parties.

Other media types may be represented by outgoing queues that are not illustrated herein for lack of drawing space such as outgoing queues for video mail, VoIP, SMS, multimedia message services (MMS), and so on. In a simplest embodiment care givers send telephone messages, contact of benefactors is made by telephone and benefactor replies are telephone messages played back to care givers that are contacted by telephone.

A queue management layer 303 is provided for enabling state-of-art queue management. Queue management layer 303 includes a queue request processing engine 317 for processing queued requests and notifications. Engine 317 may simultaneously process requests in more than one queue according to a first in first out (FIFO) arrangement. Other queue prioritization schemes may also be observed. A queue staging machine 318 is provided to manage input into the queues according to prevailing rules.

A call state monitor is provided to track the results from call attempts such as successful, failed, in progress, terminated, dropped, transferred, etc. Call state monitor 320 may be adapted to record data about call attempts for use in notification and reporting functions. A queue state manager is provided to manage queue state such as queue empty, queue full, queue disabled, and so on. Queue state manager 319 may also maintain running times for items in queue for reporting purposes such as average time in queue, queue turnaround time, queue wait time, queue saturation time, etc. Such statistics can be used to help fine tune the system.

A message generation/application program interface (API) layer 304 is provided and contains a number of internal components and interfaces to external components. A text-to speech and speech-to-text engine (TTS/STT) 320 is provided within layer 304 and is adapted to convert media from text to voice or from voice to text if required for message replies delivered to care givers over preferred media channels. If a voice reply is recorded during IVR interaction with a care benefactor, that recorded file can be parsed and converted into text for insertion into the message body of an email or text message. Likewise, a voice message ultimately delivered to a care benefactor may begin as a typed message that is parsed and converted to a synthesized voice file for insertion into an IVR routine.

A voice recording system 323 is provided for the purpose of enabling care givers to pre-record and to record voice messages. Layer 304 also includes an API 321 to an email server, an API 322 to a VoIP server, an API 324 to an e-fax server, and an API 325 to an IVR system. Such APIs enable the contact initiation server to access and interact with the other external servers mentioned.

Components 300 include a database layer 305 enabling access to data stored in a repository associated, for example, to the contact initiation server. A backup and recovery layer 306 is provided to preserve system access to data in the event of data loss, corruption, or power failure.

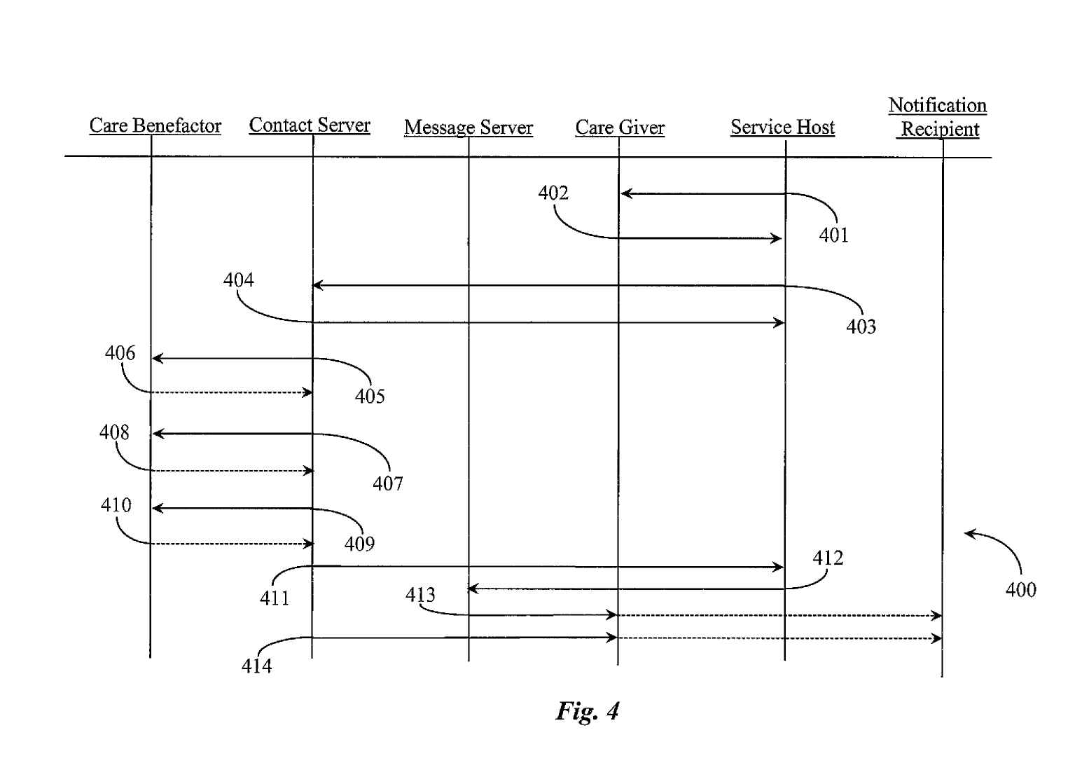

FIG. 4 is a contact sequence chart illustrating a process 400 for contacting a care benefactor and providing call attempt notification results. In this example it is assumed that the care giver has pre-configured the service to call the care giver at a pre-determined time to solicit a message to send to a care benefactor. In this case the service host calls the care giver at a pre-determined time during a configured call window. The service host may use IVR interaction and voice recording software to obtain a new message to deliver to a care benefactor. In one embodiment the service host leverages the contact server to place the call to the care giver.

The reason for first calling the care giver before calling the care benefactor is simply to obtain a current message or to confirm use of an existing voice file already on record. The service leveraging the contact server may place a number of calls to the care giver and the care benefactor within the period defined by a call window. A call window represents a period of time within which the service will place calls to the care benefactor on behalf of the care giver.

At step 401 the service host contacts the care giver at a pre-determined time after the call window activates and solicits the care giver to record a message to deliver or to select an existing message to deliver. During this step the service may identify itself and ask for a password or personal identification number (PIN) or code from the care benefactor for authentication purposes. At step 402 the care giver authenticates with the service and after a prompt may choose to confirm a default voice message, select from a pool of existing voice messages, or record a new voice message for delivery.

The care giver provides the input to the service host at step 402. The service host may record a new message spoken by the care giver and the care giver may be given an opportunity to keep or to overwrite the recorded message at step 402. The care giver may restart the loop and re-record a message until the user is satisfied with the message. The service host allots enough time to obtain a new message before a scheduled contact attempt with the care benefactor.

The service host sends the information to the contact server at step 403 and the call request becomes an active call pending. The contact server has the correct call number and at least location information to the correct voice message to insert into the IVR sequence. The contact server responds to the service host and confirms a successful receipt of information at step 404. With respect to queue, the call request becomes an active pending call to be placed according to a defined schedule.

The contact server attempts to contact the care benefactor at a predetermined time within the pre-determined call window in step 405. The contact server has at least one telephone number for the care benefactor and may try a priority number first. In this example there is no answer at that number after a timeout period, which may be defined by a specific number of rings. At step 406 contact server understands that the first attempt failed as indicated by a broken directional arrow from the care benefactor back to the contact server indicative of no answering party. This determination of a failed call may also be made if an answering machine or service answers the call and the benefactor is not available.

At step 407 the contact server makes a second attempt to reach the care benefactor using another provided number. The care giver may have pre-set a number of times to attempt contact and the numbers to call. At step 408 the contact server determines that the subsequent contact attempt at the next number is also a failure. A timeout or an answering machine pickup may be used to determine the failure of the attempt. The contact server makes a third attempt at yet another number at step 409. After a timeout or machine answer the server determines the attempt a failure at step 410. There are a variety of possible retry sequences that may be ordered as part of a contact instruction. In this example, three attempts were made to contact the care benefactor using a different number for each attempt beginning with the highest priority number. More or fewer attempt may be ordered. Likewise, more than one attempt may be made to a same number.

In this example, the system was unable to locate and connect with the care benefactor. In this event the contact server may report state back to the service host at step 411. The service host may generate a text message alert at step 412 and may use a message server to deliver the text alert to the care giver at step 413 and optionally to one or more additional parties or notification recipient. The call failure may be unusual given the time of day and care benefactor schedule at the time of the call attempts therefore causing some concern. A notification recipient may be set up in advance and may be a neighbor living next door to the care benefactor who has previous instruction to walk over and check on the care benefactor if a text alert is received. A notification recipient may also be an emergency service, paramedic facility, or some other professional responder.

In one embodiment the contact server may be pre-ordered to attempt to contact the care giver directly by telephone at step 414 upon failing to connect with the care benefactor in the allotted amount of time. The contact server may also be pre-ordered to contact a notification recipient by telephone as illustrated by broken arrow. A special message may be prepared in advance for the event of contact attempt failure. Such a message may identify the care benefactor and the address of the care benefactor and may state that the care benefactor could not be contacted and that there may be an emergency. After receiving such a message a notification recipient located near the care benefactor may check in on the situation.

In one embodiment voice recognition software is trained to recognize an emergency word or phrase taught to the care benefactor and known to the system and care giver. In this case if a call attempt is successful but the care benefactor is suffering some type of problem or emergency that requires direct attention, the care benefactor may vocalize the emergency word or phrase when the IVR prompts the care benefactor to record a reply. In another embodiment, the IVR voice recognition feature is always on and the benefactor may state the emergency word or phrase as soon as the ringing event is answered. In still another embodiment the emergency code may be one or a series of touch tone telephone buttons that the voice application recognizes as an emergency code. Once the IVR recognizes the care benefactors emergency word or phrase or tone input the contact server may immediately call the care giver and notification recipient and a medical response team if necessary. The contact server may put the care benefactor on hold and may then connect the care benefactor by telephone to a live responder, to the care giver or to a notification recipient. In one embodiment alerts may be sent out by text messaging to cellular telephones along with email alerts to email addresses, and direct telephone call attempts. There are many different possibilities.

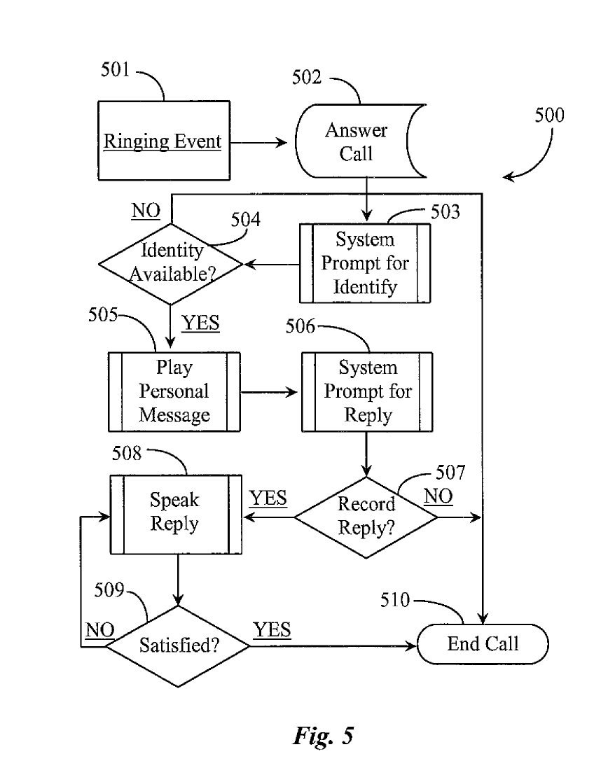

FIG. 5 is a process flow chart illustrating a process 500 for receiving a call prompt and recording a reply. When the service of the present invention contacts a care benefactor by telephone it provides the opportunity for the care benefactor to record a reply that is delivered back to the care giver. At step 501 the care benefactor receives a ringing event. At step 502 the care benefactor answers the telephone.

At step 503 the service identifies itself by trade name or logo, and the name of the care giver so the care benefactor knows immediately who the call is from and prompts the care benefactor for identification to confirm that the care benefactor is actually the party that answered the ringing event. At step 504 the system determines if the correct identity is available. In this step the service recognizes a spoken identification number or word. In one embodiment touch tone keys can be used to key the identity in. If the correct identification is not obtained in step 504 then the process may end with a call termination at step 510. In this event the system may consider the call attempt a failure and send a notification to that effect to the care giver and one or more notification recipients.

In one embodiment where no identity is available at step 504, an intermediary step may be provided whereby the service prompts the party who answered the call with a question such as “Is the care benefactor is within reach of the telephone?”. The process may proceed according to a yes or no answer from the call party. If the care benefactor is there but did not answer the telephone the benefactor may take the phone and restart the validation portion of the voice application to authenticate to the service.

If the service determines at step 504 that the care benefactor provided correct identification, then the system plays a personal message created for the benefactor by the care giver at step 505. The personal message may be created on the fly by the care giver just before the contact attempt is made resulting in the ringing event at step 501. The personal message may be recorded and reused as a generic message. The personal message may be recorded in the care givers voice or it may be a synthesized voice recording created from parsed text. In one embodiment a sample of the care givers voice may be taken by the system and used when creating a synthesized voice that matches the care givers voice tone and voice inflection pattern.

A care giver may have several pre-created voice files on record that the system may incorporate in a voice application used to interact with care givers. The voice application may be a template application with slots for the voice messages and other personal particulars like the care benefactors name for example.

The system prompts the care benefactor for a voice reply at step 506 after the personal message is played at step 505. The care benefactor may decide at step 507 whether to record a reply. If at step 507 the care benefactor decides against a reply, the call may be terminated at step 510. If a call to a benefactor is answered and a personal message is played by the IVR system then the call attempt may be deemed successful even though there was no reply.

If at step 507 the care giver decides to record a reply then at step 508 the care benefactor may speak a reply, typically after a tone, into the telephone handset while the system records the reply. The system may be adapted to allow the care benefactor to re-record a reply. At step 509 the system may prompt a care benefactor for a satisfaction level after a reply has been recorded and played back to the benefactor. If the benefactor is not satisfied with the recording just made, the process loops back to step 508 where the benefactor may re-speak a reply to produce another voice file that replaces the previous recording. When the care benefactor is satisfied with the recording of the reply the process terminates at step 510 and the call is ended.

Process steps 500 are used in conjunction with a telephone, and an IVR system running a voice application. However, this should not be construed as a limitation of the invention. A Web-based service interface may also be provided that uses digital voice messages or voice mail whereby a care benefactor may open an email message and hear the incoming message from the care giver and may be prompted to record a voicemail reply. Video may also be made part of the process. The inventor uses telephone interaction as an example of the present invention because it is the most prevalent form of communication for the elderly and disabled. The care benefactor may receive telephone calls from the care benefactor that are initiated from a Web-based service.

One with skill in the art of voice application interaction will appreciate that there may be many process flow variations or options provided within the flow of steps 500 without departing from the spirit and scope of the present invention. For example, steps may be introduced that play advertising and enable a care benefactor to obtain more information about certain products. The may be an emergency procedure to follow in case of certain circumstances such as the care benefactor answering under duress of some problem the care benefactor is currently experiencing. Moreover, the care benefactor, like the care giver may retain multiple generic reply recordings labeled such that the benefactor may easily select individual ones of them using the voice interaction. The care benefactor may assign numbers to them so that the push of a button selects a specific pre-recorded reply as opposed to recording a reply every time the care giver calls. There are many possibilities.

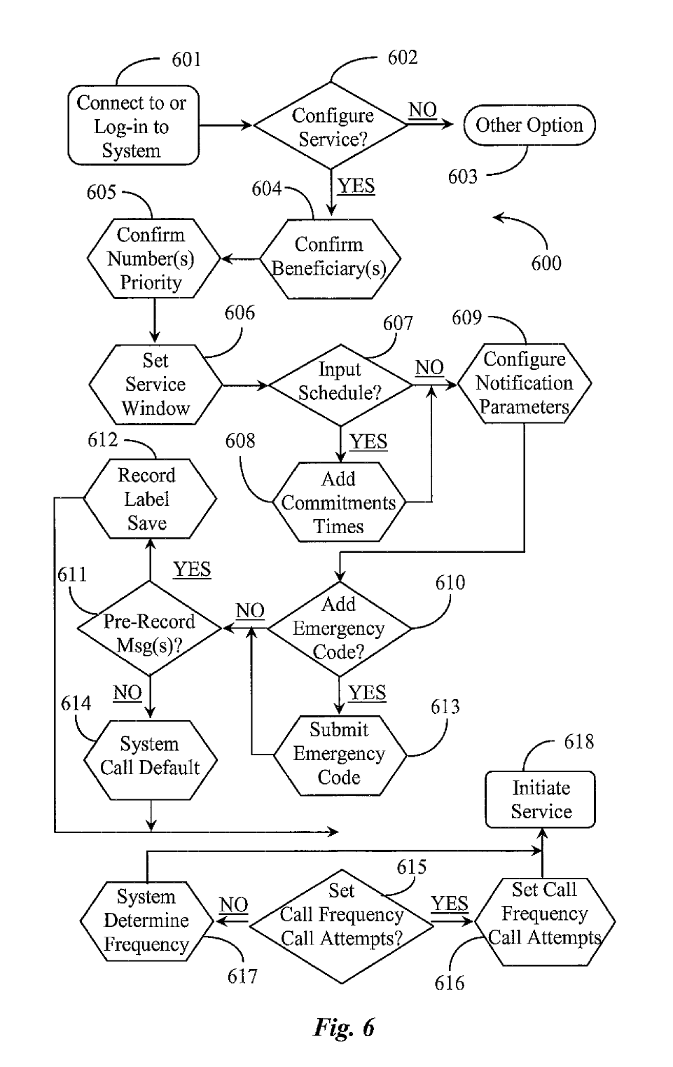

FIG. 6 is a process flow chart illustrating a process 600 for configuring and initiating service according to an embodiment of the present invention. At step 601 a care giver may log into the service of the invention. The point of interface may be a Web page accessed via a network-capable computing appliance such as a PC, Laptop, Cellular telephone, or some other network capable computing device.

Once the care giver is logged into the service the care giver decides at step 602 whether to configure a service window to monitor one or more than one care benefactor. If the care giver decides not to configure service at step 602 then at step 603 the process ends with the care giver perhaps selecting from other options such as account management or update billing information.

If the care giver decides to configure service at step 602 then at step 604 the care giver may identify one or more than one care benefactors. At step 605 the care giver may confirm or provide the contact information for the one or more care benefactors based on priority. For example, two or more numbers may represent telephone contact information for one benefactor, a home number, a cell number, and a number of a friend in that order of priority. The service of the invention may call the home number and failing to connect may attempt the cellular number. If both fail to cause a connection with the care benefactor, the friend's number might be dialed as a last effort to connect.

The care giver may set the service window at step 606. The service window may be defined as a period of time within which the service makes calls on behalf of the care giver. In one embodiment a care giver may input a care benefactor's planned schedule of commitments so that in the event that the service will select call times, the service may work between commitments. At step 607 the care giver decides whether to input a schedule for a care benefactor. If the care giver decides to input a schedule, then at step 608 the care giver may add commitments and the times and dates of those commitments within the service window.

Whether a schedule is added or not, the process moves to step 609 where the care giver may configure notification parameters into the service. Such information includes whom to notify and the contact information for the service to use to send notifications. Notification may be triggered by certain events like failure of care benefactor to answer when called.

The care benefactor may have an emergency code or phrase that the service may be configured to understand and as a result, send notifications and activate some pre-arranged emergency procedure. The exact nature of emergency handling may depend on the nature of the care benefactor's current medical condition or state. At step 610 the care giver may decide whether to add an emergency code or not. If the care giver decides to add an emergency code, then at step 613 the code may be submitted. In this step the conditions which trigger the emergency, an emergency notification routine, and requested procedure or instructions may also be entered including where to take the care benefactor in case of ambulance.

The process may move to step 611 whether or not an emergency code is added. At step 611 the care giver may decide whether to pre-record any messages for system (voice application) use during interaction with the care benefactor. In one embodiment there are no messages recorded because the process is a first time configuration. In another embodiment there may be pre-existing messages already known to the service. The system may provide message management services and an interface that enables the care giver to add voice messages, delete voice messages, save voice messages, modify voice messages, and label voice messages for service. Voice messages may be created from typed text or recorded from an audio input or interface.

The system may have a series of default messages on hand that a care giver may select from and may personalize to some extent by submitting a voice sample for inflection and tone. If at step 611 the care giver decides to pre-record one or more messages then at step 612 the user may record label and save one or more messages for use. It will be appreciated that from time to time some messages will be obsolete and new message content will be required as a benefactor's situation changes or evolves. If the care giver decides not to add or change any messages at step 611 the care giver may select messages from a system default library at step 614. Files in a message library may be generic message templates with user slots where the care giver may speak to record and insert words or phrases into the slots according to one embodiment of the invention.

The process moves to step 615 whether pre-recorded messages are selected for service or new messages are added to the service. At step 615 the care giver may decide to set a call frequency and number of call attempts for a service window. For example, if the service window is one day the number of call attempts may be three times during the day. If the service window is two weeks the call frequency may be every other day with two calls per day. The care giver may customize the service according to need. There may be a service limit on the call frequency and number of calls.

If the care giver decides to set the call frequency/number of calls at step 615, then at step 616 the care giver configures the call frequency and number of attempts into the service for application to calls made by the service within the stated service window. The care giver has the option of not setting the call number and frequency and may allow the system to make this determination at step 617. After all of the configuration steps are complete, the care giver may initiate or activate the service window and the service will begin at the scheduled time.

One with skill in the art of service configurations will note that the process steps outlined in this example are not required to be completed in any specific order to practice the invention. For example, step 606 may be completed before step 605. Call frequency may be defined as the number of times per period that the service attempts to connect to a care benefactor. The number of call attempts may be defined as the number of call attempt made to one or more number during a specific attempt to contact a care benefactor. A service window may be a day with a call frequency of 3 times (morning, noon, and evening) and with the number of attempts set to two attempts for each call period of morning, noon and evening. Many other configurations are plausible.

The service of the present invention may be configured and initiated through a voice interface or through a Web-based interface. The service may be practiced over multiple and disparate networks which are physically bridged for communication.

It will be apparent to one with skill in the art that the service and system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A system for monitoring individuals on behalf of one or more caregivers comprising:
an Internet-connected server;
software executing from a digital storage medium associated with the server;
an interactive interface provided by the software for enabling caregivers and individuals to input and access information; and
information stored in a data repository associated with the server regarding at least contact data for the individuals, media files representing recorded voice messages, and schedule parameters for initiating and processing call requests directed from the one or more caregivers;
characterized in that the interactive interface enables one or more caregivers to provide specific contact, configuration and schedule data for system use and wherein the system initiates contact attempts by proxy on behalf of the one or more caregivers based on the data provided, including reporting contact attempt results and recording and forwarding any contact replies.

2. The system of claim 1 wherein the monitoring is by telephone or by voice messaging through equipment adapted to practice the invention.

3. The system of claim 1 wherein the interactive interface is a browser-based interface.

4. The system of claim 1 wherein the individuals monitored comprise one of elderly persons or mentally impaired individuals that maintain independent to semi-independent lifestyles.

5. The system of claim 1 wherein there is more than one caregiver, the caregivers belonging to a group subscribed as an enterprise to a service provided by the system.

6. The system of claim 1 wherein calls are made to the one or more caregivers to solicit messages before attempting to contact one or more monitored individuals during a given service window.

7. The system of claim 2 wherein telephone equipment is leased for the purpose of practicing the invention.

8. The system of claim 1 wherein the contact parameters are telephone numbers and the media files are voice files useable by an interactive voice response system.

9. A method for initializing monitoring of care benefactors by proxy over a network comprising the steps:
(a) providing to a service through an interactive interface provided by software executing from a digital storage medium associated with an Internet-connected server on the network, parameters for monitoring one or more care benefactors including defining a service window;
(b) providing to the service through the interactive interface, parameters for sending notification relative to contact attempt result states during monitoring;
(c) providing to the service through the interactive interface or through a voice connection, one or more messages for voice presentation to care benefactors; and
(d) activating a service window of time within which monitoring commences.

10. The method of claim 9 wherein the care benefactors are elderly or physically or mentally impaired individuals leading an independent or semi-independent lifestyle.

11. The method of claim 9 wherein in step (a) the parameters include care benefactor identification, contact information, optionally commitment schedule information of the care benefactor.

12. The method of claim 9 wherein in step (b) the parameters include notification recipient identification, contact information, and optionally emergency plan instructions.

13. The method of claim 9 wherein in step (a) through (c) the interactive interface is a Web-based interface accessible through an Internet-connected server.

14. The method of claim 9 wherein in step (c) the one or more messages are typed into a dialog box of the interactive interface and then are parsed and converted into synthesized voice messages.

15. The method of claim 9 wherein in step (c) the one or more messages are spoken over the voice connection and recorded as digital voice files.

16. The method of claim 9 wherein in step (c) the voice messages are presented to care benefactors over a voice connection using a voice application running on an interactive voice response unit.

17. The method of claim 16 wherein the voice connection is a connected telephone call.

18. The method of claim 9 wherein in step (d) activation of the service window is automatic and performed by the service.

19. The method of claim 9 wherein step (c) occurs periodically just before call attempts are made within a given service window.

20. The method of claim 9 wherein in step (c) the voice connection is one of a telephone or voice over Internet protocol (VoIP) connection.
